(19) United States
(12) Patent Application Publication
(10) Pub. No.: US 2014/0099964 A1
(43) Pub. Date: Apr. 10, 2014

(54) APPARATUS AND METHOD FOR CONFIGURING CELL IN WIRELESS COMMUNICATION SYSTEM

(71) Applicant: Samsung Electronics Co., Ltd., Suwon-si (KR)

(72) Inventors: In-Taek LEE, Seoul (KR); Byoung-Ha YI, Seoul (KR)

(73) Assignee: Samsung Electronics Co., Ltd., Suwon-si (KR)

(21) Appl. No.: 14/050,879

(22) Filed: Oct. 10, 2013

(30) Foreign Application Priority Data
Oct. 10, 2012 (KR) 10-2012-0112266

(51) Int. Cl. H04W 16/18; H04W 8/02

(52) U.S. Cl. CPC H04W 16/18; H04W 8/02
USPC 455/448

(57) ABSTRACT

A method for configuring a cell in a wireless communication system is provided. The method includes generating a virtual field based on information of a Remote Radio Header (RRH), generating grids in the virtual field at intervals, generating a virtual coverage map by regarding each of the grids as a virtual User Equipment (UE) and determining a serving RRH for each of the virtual UEs, determining grids which are located at a boundary region among RRHs among grids included in the virtual coverage map as boundary region grids, configuring a cell such that the cell includes less than or equal to a maximum sub-cell number of sub-cells, excluding boundary region grids included in a same cell among the boundary region grids from the boundary region grids, and selecting a sub-cell grouping combination which has a minimum number of boundary region grids among all sub-cell grouping combinations, and configuring the cell using the selected sub-cell grouping combination.

### CROSS-REFERENCE TO RELATED APPLICATION(S)

This application claims the benefit under 35 U.S.C. §119(a) of a Korean patent application filed on Oct. 10, 2012 in the Korean Intellectual Property Office and assigned Serial No. 10-2012-0112266, the entire disclosure of which is hereby incorporated by reference.

### TECHNICAL FIELD

The present disclosure relates to an apparatus and method for configuring a cell in a wireless communication system. More particularly, the present disclosure relates to an apparatus and method for configuring a cell so as to minimize a number of handover occurrences for a User Equipment (UE).

### BACKGROUND

Generally, wireless communication systems have been implemented as cellular communication systems, and the cellular communication systems have been operated such that each Node B thereof has a sector structure. In a cellular communication system, there is a plurality of radio units; however, the individual radio units of the plurality of radio units are not spatially distinct from one another.

In a cellular communication system of the related art, a location in which a Node B is deployed is determined by analyzing various parameters, such as cell capacity of a region in which a network will be deployed, cell coverage, or the like. If a Node B is additionally deployed (due to various problems such as cell capacity shortages, a coverage hole, etc.), a location in which the Node B will be additionally deployed should be determined by considering additional interference which may occur between pieces of User Equipment (UE) located in a cell which has been already deployed.

FIG. 1 schematically illustrates a process for configuring a cell in a cellular communication system according to the related art.

As illustrated in FIG. 1, in a case in which a cell has been configured in the cellular communication system and the cell capacity of the specific cell 100 is insufficient, and if a cell 111 which will be additionally deployed is not a cell having a relatively small cell coverage area, such as a pico cell, a femto cell, etc., then the additionally deployed cell 111 will provide additional interference to neighboring cells. Due to this additional interference, a situation in which a total network capacity of the cellular communication system decreases may occur.

On the other hand, if a relay is operated within a cell in the cellular communication system, a relevant radio unit can be placed in a manner that is spatially distant. In this regard, it is possible that cell coverage expands and a strong electric field expands. However, since the relay uses a scheme in which the same signal is repeatedly transmitted, the relay expands cell coverage, but may not increase total network capacity.

Accordingly, a need exists for configuring a cell so as to be capable of deploying an additional cell therein without causing interference among old cells which have been previously deployed in order to expand cell coverage and to increase total network capacity in a wireless communication system.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for configuring a cell in a wireless communication system.

Another aspect of the present disclosure is to provide an apparatus and method for configuring a cell thereby minimizing a number of handover occurrences for a UE and additionally deploying a cell in a wireless communication system.

Yet another aspect of the present disclosure is to provide an apparatus and method for configuring a cell thereby preventing interference among cells which have been already deployed and additionally deploying a cell in a wireless communication system.

Still another aspect of the present disclosure is to provide an apparatus and method for configuring a cell thereby additionally deploying a cell in order to expand cell coverage and increase total network capacity in a wireless communication system.

Yet another aspect of the present disclosure is to provide an apparatus and method for configuring a cell thereby additionally deploying a cell without interference among old cells which have been already deployed in order to expand cell coverage and increase total network capacity in a wireless communication system.

In accordance with an aspect of the present disclosure, an apparatus for configuring a cell in a wireless communication system is provided. The apparatus includes a controller configured to generate a virtual field based on information on a Remote Radio Header (RRH), to generate grids in the virtual field at intervals, to generate a virtual coverage map by regarding each of the grids as a virtual User Equipment (UE) and determine a serving RRH for each of the virtual UEs, to determine grids which are located at a boundary region among RRHs among the grids included in the virtual coverage map as boundary region grids, to configure a cell such that the cell includes less than or equal to a maximum sub-cell number of sub-cells, to exclude boundary region grids included in a same cell among the boundary region grids from the boundary region grids, to select a sub-cell grouping combination which has a minimum number of boundary region grids among all sub-cell grouping combinations, and to configure the cell using the selected sub-cell grouping combination, wherein the maximum sub-cell number is permitted per each cell in the wireless communication system.

In accordance with another aspect of the present disclosure, an apparatus for configuring a cell in a wireless communication system is provided. The apparatus includes a controller configured to detect sub-cell information on a new sub-cell in which an RRH is deployed, to detect cell configuration information for old sub-cells, to detect received power from the old sub-cells to the new sub-cell using a path loss function, an antenna parameter and transmission power information, to detect a sub-cell grouping combination in which a total number of handover occurrences in the wireless communication system is minimized and a sum of received power in the new sub-cell is minimized from among all sub-cell grouping combinations which are possible to be generated in the wireless communication system, and to configure a cell using the detected sub-cell grouping combination.

In accordance with another aspect of the present disclosure, an apparatus for configuring a cell in a wireless communication system is provided. The apparatus includes a controller configured to collect movement information for a UE among sub-cells included in the wireless communication system, if an automatic optimal cell configuration period occurs, to detect a sub-cell grouping combination in which a total number of handover occurrences in the wireless communication system is minimized from among all sub-cell grouping combinations which are possible to be generated in the wireless communication system using the movement information for the UE, and to configure a cell using the detected sub-cell grouping combination.

In accordance with another aspect of the present disclosure, a method for configuring a cell in a wireless communication system is provided. The method includes: generating a virtual field based on information on an RRH, generating grids in the virtual field at intervals, generating a virtual coverage map by regarding each of the grids as a virtual UE and determining a serving RRH for each of the virtual UEs, determining grids which are located at a boundary region among RRHs among grids included in the virtual coverage map as boundary region grids, configuring a cell such that the cell includes less than or equal to a maximum sub-cell number of sub-cells, excluding boundary region grids included in a same cell among the boundary region grids from the boundary region grids, and selecting a sub-cell grouping combination which has a minimum number of boundary region grids among all sub-cell grouping combinations, and configuring the cell using the selected sub-cell grouping combination, wherein the maximum sub-cell number is permitted per each cell in the wireless communication system.

In accordance with another aspect of the present disclosure, a method for configuring a cell in a wireless communication system is provided. The method includes: detecting sub-cell information on a new sub-cell in which an RRH is deployed, detecting cell configuration information for old sub-cells, detecting received power from the old sub-cells to the new sub-cell using a path loss function, an antenna parameter and transmission power information, detecting a sub-cell grouping combination in which a total number of handover occurrences in the wireless communication system is minimized and a sum of received power in the new sub-cell is minimized from among all sub-cell grouping combinations which are possible to be generated in the wireless communication system, and configuring the cell using the detected sub-cell grouping combination.

In accordance with another aspect of the present disclosure, a method for configuring a cell in a wireless communication system is provided. The method includes collecting movement information for a UE among sub-cells included in the wireless communication system, if an automatic optimal cell configuration period occurs, detecting a sub-cell grouping combination in which a total number of handover occurrences in the wireless communication system is minimized from among all sub-cell grouping combinations which are possible to be generated in the wireless communication system using the movement information for the UE, and configuring the cell using the detected sub-cell grouping combination.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 schematically illustrates a process for configuring a cell in a cellular communication system according to the related art;

FIG. 2 schematically illustrates a method in which a cell is initially configured using a virtual coverage map generated in a field in which three Remote Radio Headers (RRHs) are deployed in a wireless communication system according to an embodiment of the present disclosure;

FIG. 3 illustrates a process for initially configuring a cell using a virtual coverage map generated in a field in which three RRHs are deployed in a cell configuration apparatus in a wireless communication system according to an embodiment of the present disclosure;

FIG. 4 illustrates a process for automatically configuring a cell when an RRH is added after an initial cell configuration has been completed in a wireless communication system according to an embodiment of the present disclosure;

FIG. 5 illustrates a process for optimally configuring a cell while a wireless communication operates, regardless of a new sub-cell addition, after a cell has been configured using one of an initial cell configuration method and an automatic cell configuration method in a wireless communication system according to an embodiment of the present disclosure; and

FIG. 6 schematically illustrates an internal structure of a cell configuration apparatus in a wireless communication system according to an embodiment of the present disclosure.

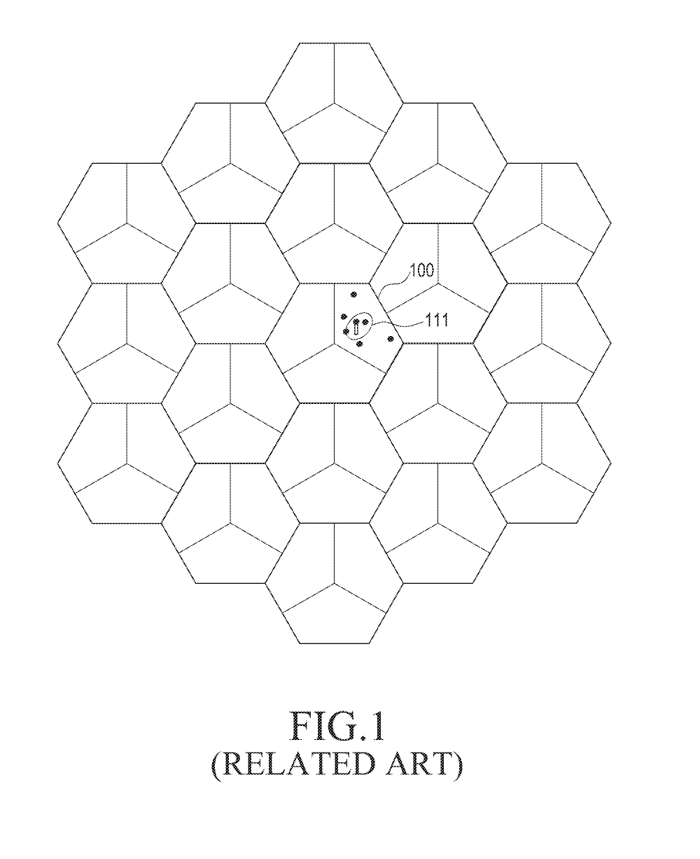

Throughout the drawings, like reference numerals will be understood to refer to like parts, components, and structures.

### DETAILED DESCRIPTIONS

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although ordinal numbers such as “first,” “second,” and so forth will be used to describe various components, those components are not limited herein. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing embodiments only and is not intended to be limiting. As used herein, the singular forms are intended to include the plural forms as well, unless the context clearly indicates otherwise. It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology.

An embodiment of the present disclosure proposes an apparatus and method for configuring a cell in a wireless communication system.

Another embodiment of the present disclosure proposes an apparatus and method for configuring a cell so as to minimize a number of handover occurrences for a User Equipment (UE) and for additionally deploying a cell in a wireless communication system.

Still another embodiment of the present disclosure proposes an apparatus and method for configuring a cell so as to prevent interference among cells which have been already deployed and additionally deploying a cell in a wireless communication system.

Yet another embodiment of the present disclosure proposes an apparatus and method for configuring a cell to include an additionally deployed cell in order to expand cell coverage and to increase total network capacity in a wireless communication system.

Still another embodiment of the present disclosure proposes an apparatus and method for configuring a cell thereby additionally deploying a cell without interference among old cells which have been already deployed in order to expand cell coverage and increase total network capacity in a wireless communication system.

Further, an apparatus and method proposed in an embodiment of the present disclosure may be applied to various mobile communication systems such as a Long Term Evolution (LTE) mobile communication system, a Long Term Evolution-Advanced (LTE-A) mobile communication system, a High Speed Downlink Packet Access (HSDPA) mobile communication system, a High Speed Uplink Packet Access (HSUPA) mobile communication system, a High Rate Packet Data (HRPD) mobile communication system proposed in a 3^{rd} Generation Project Partnership 2 (3GPP2), a Wideband Code Division Multiple Access (WCDMA) mobile communication system proposed in a 3GPP2, a Code Division Multiple Access (CDMA) mobile communication system proposed in a 3GPP2, and an Institute of Electrical and Electronics Engineers (IEEE) mobile communication system.

Firstly, a sub-cell grouping scheme will be described.

One cell may include at least one sub-cell, and a group which uses the same control channel and includes at least one sub-cell is called as a ‘sub-cell group’.

The sub-cell grouping scheme denotes a scheme including a sub-cell group which uses the same control channel in a wireless communication system which is operated using Remote Radio Headers (RRHs) that are deployed across a network.

In a cell configuration scheme which includes a plurality of cells per cell, cell coverage changes if a set of sub-cells included in a cell is changed, and thus the number of outage occurrences and the number of handover occurrences within a network may change. That is, when one cell includes a plurality of sub-cells, an outage occurrence probability may decrease compared with a case in which one cell includes one sub-cell due to a Radio Frequency (RF) combining effect. Further, if a sub-cell set is changed and the number of cells included in a wireless communication system is constant, a change rate of an outage occurrence probability due to the sub-cell set change is relatively small, so the sub-cell grouping scheme may minimize the number of handover occurrences by assuming that RRHs are deployed in order to prevent a coverage hole within a network. In an embodiment, a total number of handover occurrences in the network, i.e., the wireless communication system may be expressed as Equation (1).

$$TotalHO = {\sum }_{j = 1}^{{N}_{cell} - 1} {\sum }_{i = 0}^{{N}_{cell} - 1} \frac{( {N}_{{HandIn}_{i , j}} + {N}_{{HandOut}_{i , j}} )}{2} \qquad Equation ( 1 )$$

In Equation (1), TotalHO denotes the total number of handover occurrences, N_{cell} denotes the number of cells included in the network, N_{HandIn}_{_{i,j}} denotes the number of hand in occurrences for the jth cell, and N_{HandOut}_{_{i,j}} denotes the number of hand out occurrences for the jth cell. In an embodiment, the hand in is performed from the ith cell to the jth cell, and the hand out is performed from the jth cell to the ith cell. If it is assumed that the number of UEs is always constant, N_{HandIn}_{_{i,j}} is equal to N_{HandOut}_{_{i,j}}, so Equation (1) may be expressed as Equation (2).

$$TotalHO = {\sum }_{j = 1}^{{N}_{cell} - 1} {\sum }_{\begin{matrix}i = 0 \\ i \neq j\end{matrix}}^{{N}_{cell} - 1} {N}_{{HandIn}_{i , j}} \qquad Equation ( 2 )$$

If it is assumed that there is no ping pong event while a UE performs a handover operation, the UE handover operation succeeds, and UEs which are located at a cell edge region perform a handover operation having the same probability, Equation (2) may be expressed as Equation (3).

$$TotalHO = {\sum }_{j = 1}^{{N}_{cell} - 1} {\sum }_{{i = 0}_{i \neq j}}^{{N}_{cell} - 1} ρ \cdot {N}_{{edge}_{i , j}} \qquad Equation ( 3 )$$

In Equation (3), ρ denotes a handover occurrence probability, and N_{edge}_{_{i,j}} denotes the number of UEs which are overlapped located at a boundary region of the ith cell among UEs which are located at a boundary region of the jth cell.

In order to minimize the total number of handover occurrences in the network, Equation (4) may be derived using Equation (3) and a sub-cell term.

$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} ρ \cdot {N}_{{edge}_{il , jk}} \qquad Equation ( 4 )$$

In Equation (4), N_{subcell}_{ⱼ} denotes the number of sub-cells included in the jth cell, and N_{edgel}_{_{iI,jk}} denotes the number of boundary regions which are overlapped with an lth sub-cell included in the ith cell among boundary regions for the kth sub-cell included in the jth cell.

In Equation (4), ρ denotes the handover occurrence probability like Equation (3) and is set to a fixed value regardless of a sub-cell grouping scheme. So, Equation (4) may be expressed as Equation (5).

$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}} \qquad Equation ( 5 )$$

The sub-cell grouping scheme is a scheme in which a sub-cell group is generated such that a functional value for a function expressed in Equation (5) is minimized and the generated sub-cell group is allocated to each cell included in the wireless communication system. If the sub-cell grouping scheme proposed in an embodiment of the present disclosure is used, the cell may be configured so as to minimize a total number of handover occurrences in the network. A description of a sub-cell grouping method proposed in an embodiment of the present disclosure follows.

The sub-cell grouping methods of the present disclosure may be classified into three methods, i.e., an initial cell configuration method which is used if cells are initially configured, an automatic cell configuration method which is used if a new sub-cell is added after a cell is configured using the initial cell configuration method, and an automatic optimal cell configuration method which is used regardless of new sub-cell addition after a cell is configured using one of the initial cell configuration method and the automatic cell configuration method. A description of sub-cell grouping methods follows.

(1) Initial Cell Configuration Method:

If a cell is configured by deploying a distributed-type multiple RRH, a network of a radio communication system does not provide a configuration service, so a cell configuration apparatus instead configures a cell by considering a deployment location of each RRH. The cell configuration apparatus performs a cell configuration operation for a total number of cells included in the wireless communication system, and may be implemented as a separate apparatus, a Base Station Controller (BSC), or a device included in a Node Bs. The cell configuration apparatus generates a virtual coverage map by generating a grid based on a virtual UE within a field in a deployed RRH. After transmission power, an antenna gain, and path loss for each of the RRHs are set to a virtual value, each grid selects a serving RRH as an RRH which transmits a reference signal with maximum signal strength. In this regard, the virtual coverage map is generated such that each of the RRHs includes related grids. In an embodiment, the reference signal may be a pilot signal, or the like, and signal strength may be one of a Signal to Interference and Noise Ratio (SINR), a Carrier to Interference and Noise Ratio (CINR), a Channel Quality Indicator (CQI), a Received Signal Strength Indicator (RSSI), or the like. That is, a virtual coverage map is generated for each RRH such that grids which select a related RRH as a serving RRH are included in the virtual coverage map.

As described above, the cell configuration apparatus determines a boundary region grid which is located at a boundary region among cells in the generated virtual coverage map.

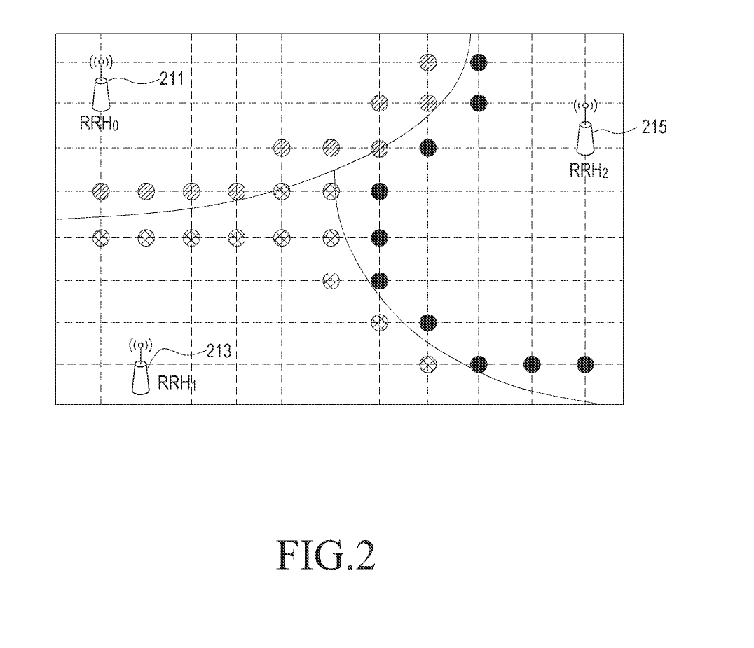

FIG. 2 schematically illustrates a method in which a cell is initially configured using a virtual coverage map generated in a field in which three RRHs are deployed in a wireless communication system according to an embodiment of the present disclosure.

Referring to FIG. 2, a virtual coverage map includes a grid and a boundary region grid which are located at a field in which three RRHs, i.e., an RRH₀ 211, an RRH₁ 213, and an RRH₂ 215 are deployed. After generating the virtual coverage map, the cell configuration apparatus detects the number of boundary region grids by performing a cell configuration operation such that each cell includes less than or equal to a maximum number of sub-cells, i.e., a “maximum sub-cell number.” The maximum sub-cell number is permitted per each cell in the wireless communication system. In an embodiment, a boundary region grid among sub-cells included in the same cell performs a cell configuration operation by excluding the boundary region grid among sub-cells from a boundary region grid among other cells such that the boundary region grid among other sub-cells will not be detected as the boundary region grid among the same cell.

In this manner, the cell configuration apparatus repeats the cell configuration operation by changing cell configuration so that the cell configuration apparatus determines a final cell configuration which minimizes the number of boundary region grids among cells. That is, in an embodiment of the present disclosure, a cell is configured in order to minimize the number of boundary region grids among the cells.

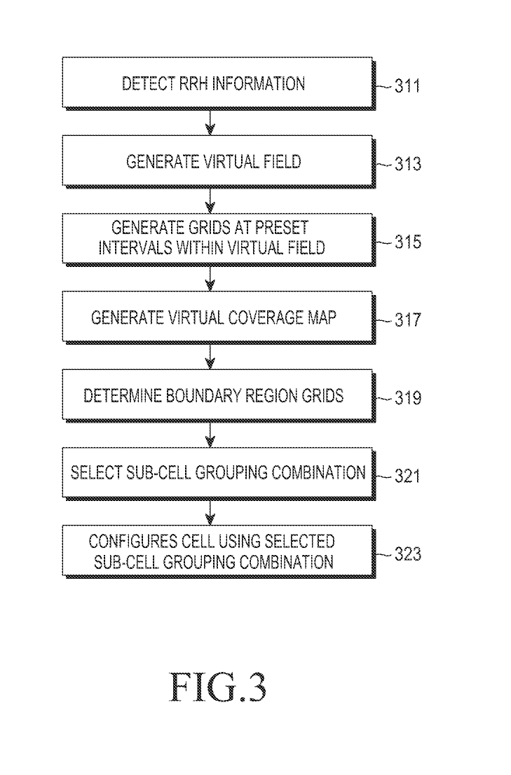

FIG. 3 illustrates a process for initially configuring a cell using a virtual coverage map generated in a field in which three RRHs are deployed in a cell configuration apparatus in a wireless communication system according to an embodiment of the present disclosure.

Referring to FIG. 3, the cell configuration apparatus detects RRH information regarding an RRH which has been initially deployed, e.g., location information and antenna associated information on the RRH, after the RRH has been initially deployed in operation 311. The location information and the antenna associated information on the RRH may include various parameters. A description for the location information and the antenna associated information on the RRH will be omitted herein. An input form for the RRH information may be implemented in various forms, and a description for the input form will also be omitted herein.

After detecting the RRH information, the cell configuration apparatus generates a virtual field based on RRH location information included in the RRH information in operation 313. The cell configuration apparatus generates grids at intervals, e.g., at regular intervals within the generated virtual field in operation 315. The cell configuration apparatus calculates an SINR for each virtual UE by regarding each of the generated grids as a virtual UE and generates a virtual coverage map in which an RRH that transmits a reference signal with a maximum SINR among the calculated SINRS is determined as a serving RRH for a related virtual UE in operation 317.

The cell configuration apparatus selects grids which are located at a boundary region among RRHs from among grids included in the virtual coverage map and determines the selected grids as boundary region grids in operation 319. The cell configuration apparatus configures cells in order to include less than or equal to a maximum sub-cell number of sub-cells, excludes boundary region grids included in the same cell from the grids determined as the boundary region grids, and selects a sub-cell grouping combination which has a minimum number of boundary region grids from among all sub-cell grouping combinations in operation 321. In an embodiment, the maximum sub-cell number is permitted per each cell in the wireless communication system.

The cell configuration apparatus finally configures a cell using the selected sub-cell grouping combination in operation 323.

(2) Automatic Cell Configuration Method:

The automatic cell configuration method is a cell configuration method which is used if a new sub-cell is added in a wireless communication system after a cell is configured using an initial cell configuration method, and a detailed description will be followed.

In a case in which a wireless network is operating after cell configuration has been completed using an initial cell configuration method, and wherein a sub-cell is additionally deployed (i.e., due to various reasons, such as a coverage hole, capacity shortages, etc.), a cell configuration apparatus should configure a cell so as to include old sub-cells, which have previously been operated, as well as a sub-cell which will be additionally deployed.

In this case, the cell configuration apparatus basically performs a cell configuration operation using a sub-cell grouping scheme described in Equation (5). However, unlike the initial cell configuration method, the cell configuration apparatus should perform a cell configuration operation which avoids a process having large network load, such as a virtual coverage map generation, in the wireless communication system. That is, the automatic cell configuration method is implemented in a form whereby a cell is configured to minimize network load. If it is assumed that the number of boundary regions which overlap with the k′th cell among boundary regions for the kth sub-cell is proportional to received power for the k′th sub-cell in the kth sub-cell, Equation (5) may be approximated as Equation (6).

$$arg min \{ TotalHO \} = arg min {\sum }_{k = 0}^{{N}_{{subcell}_{eNBindex}} - 1} {\sum }_{{k}^{′} = 0}^{{N}_{{subcell}_{eNBindex}} - 1} {α}_{k , {k}^{′}} \cdot R \times {P}_{{k}^{′} , k} , \\ {α}_{k , {k}^{′}} = \{ \begin{matrix}1 , & {subcell}_{k} \cdot CellIndex \neq {subcell}_{{k}^{′}} \cdot CellIndex \\ 0 , & {subcell}_{k} \cdot CellIndex = {subcell}_{{k}^{′}} \cdot CellIndex\end{matrix} \qquad Equation ( 6 )$$

In Equation (6), eNBindex denotes an index of an enhance Node B (eNB) into which a sub-cell is added, N_{subcell}_{ᵢ} denotes a number of sub-cells included in a cell which the ith eNB manages, and RxP_{k′k} denotes received power for the kth sub-cell in the k′th sub-cell.

In an embodiment, the cell configuration apparatus detects all sub-cell groupings which are available in a newly added sub-cell k using Equation 6, selects a sub-cell grouping which has a minimum number of boundary region grids from among the detected sub-cell groupings, and configures a cell using the selected sub-cell grouping.

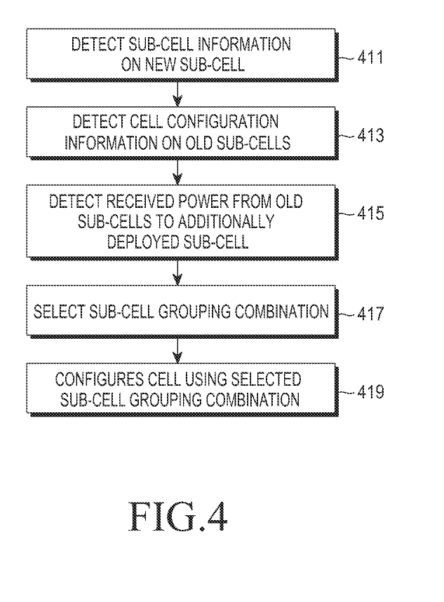

FIG. 4 illustrates a process for automatically configuring a cell according to RRH addition after an initial cell configuration has been completed in a wireless communication system according to an embodiment of the present disclosure.

Referring to FIG. 4, the cell configuration apparatus detects sub-cell information on a new sub-cell in which an RRH is additionally deployed after an initial cell configuration is completed and the RRH is additionally deployed in operation 411. In an embodiment, the sub-cell information may be one of location information, antennal associated information on the sub-cell, and the like. The location information and antennal associated information on the sub-cell may include various parameters. A description of the location information and antennal associated information on the sub-cell will be omitted herein. An input form for the sub-cell information may be implemented in various forms. A description for the input form will be omitted herein.

The cell configuration apparatus detects cell configuration information on old sub-cells which have been already deployed in operation 413. The cell configuration information on the old sub-cells may include various parameters. A description of the cell configuration information on the old sub-cells will be omitted herein.

The cell configuration apparatus detects received power from the old sub-cells to the additionally deployed sub-cell using a path loss function, an antenna parameter and transmission power information, which are set in operation 415. The cell configuration apparatus selects a sub-cell grouping combination which may satisfy Equation (6) and may minimize a sum of received power in the additionally deployed sub-cell for all cell configuration combinations which may be generated in the wireless communication system in operation 417. The cell configuration apparatus configures a cell using the selected sub-cell grouping combination in operation 419.

(3) Automatic Optimal Cell Configuration Method:

The automatic optimal cell configuration method is a cell configuration method which may be used regardless of a new sub-cell addition after a cell is configured using one of the initial cell configuration method and the automatic cell configuration method. A description thereof is as follows.

The automatic optimal cell configuration method is performed in order to optimize sub-cell grouping by adaptively reflecting a radio environment change while a wireless communication system is operated after the cell is configured. That is, the cell configuration apparatus may perform a cell configuration operation which is optimized based on movement information of a UE among sub-cells, e.g., the number of handover occurrences acquired while the wireless communication system is operated after the cell is configured. In an embodiment, Equation (5) may be expressed as Equation (7) if the number of handover occurrences among the sub-cells in the UE is applied to Equation (5).

$$arg min \{ TotalHO \} = arg min {\sum }_{k = 0}^{{N}_{{subcell}_{eNBindex}} - 1} {\sum }_{{k}^{′} = 0}^{{N}_{{subcell}_{eNBindex}} - 1} {α}_{k , {k}^{′}} \cdot {subcell}_{k} \cdot {N}_{{move}_{{k}^{′}}} , \\ {α}_{r , {r}^{′}} = \{ \begin{matrix}1 , & {subcell}_{k} \cdot CellIndex \neq {subcell}_{{k}^{′}} \cdot CellIndex \\ 0 , & {subcell}_{k} \cdot CellIndex = {subcell}_{{k}^{′}} \cdot CellIndex\end{matrix} \qquad Equation ( 7 )$$

In Equation (7), subcellₖ·N_{Move}_{_{k′}} denotes the number of UEs which move from a service coverage region of the k′th sub-cell to a service coverage region of the kth sub-cell.

Therefore, the cell configuration apparatus selects a sub-cell grouping for all of the cell configuration combinations such that a function value of a function expressed in Equation (7) may be minimized and may configure a cell using the selected sub-cell grouping.

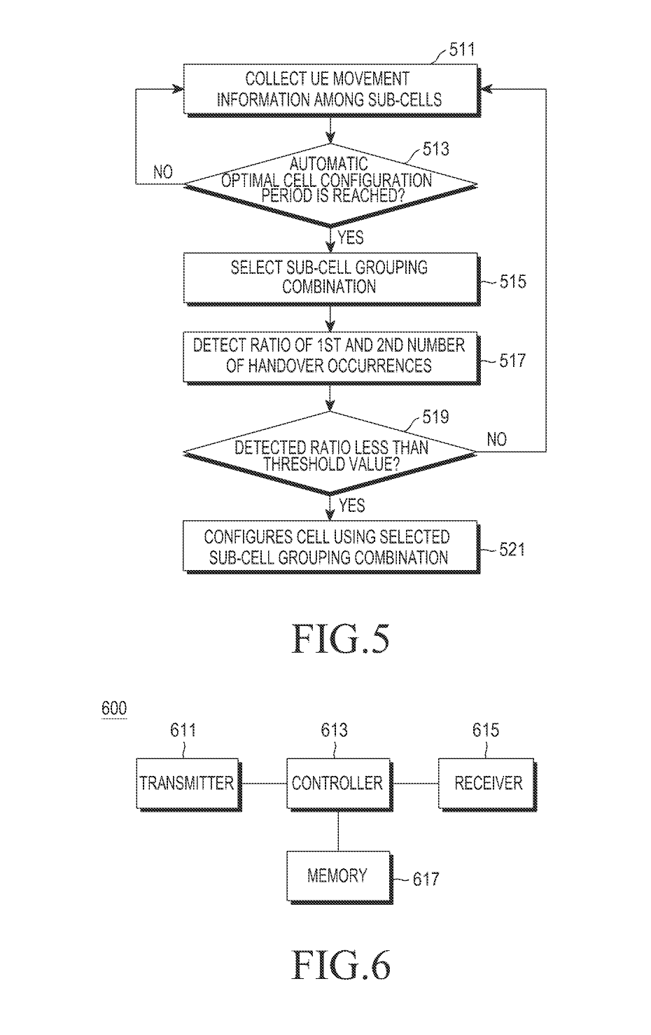

FIG. 5 illustrates a process for optimally configuring a cell while a wireless communication operates regardless of new sub-cell addition after a cell has been configured using one of an initial cell configuration method and an automatic cell configuration method in a wireless communication system according to an embodiment of the present disclosure.

Referring to FIG. 5, after a cell is configured using one of the initial cell configuration method and the automatic cell configuration method, regardless of new sub-cell addition, a cell configuration apparatus continuously collects movement information on a UE among sub-cells included in the wireless communication system in order to optimize sub-cell grouping by adaptively reflecting radio environment change while the wireless communication system is operated in operation 511. The movement information on the UE may include the number of handover occurrences in the UE, etc.

The cell configuration apparatus determines whether an automatic optimal cell configuration period is reached in operation 513. If the automatic optimal cell configuration period is reached, the cell configuration apparatus selects a sub-cell grouping combination which satisfies Equation (7) using UE movement information for each of sub-cells included in the wireless communication system for all cell configuration combinations in operation 515.

The cell configuration apparatus detects a ratio of a first number of handover occurrences in a UE to a second number of handover occurrences in the UE in operation 517. The first number of handover occurrences is the number of handover occurrences if the selected sub-cell grouping combination is applied, and the second number of handover occurrences is the number of handover occurrences if a current sub-cell grouping combination is applied. The cell configuration apparatus determines whether the detected ratio is less than a threshold value in operation 519.

If the detected ratio is less than the threshold value, the cell configuration apparatus configures a cell using the selected sub-cell grouping combination in operation 521.

If the detected ratio is equal to or greater than the threshold value, the cell configuration apparatus discards the selected sub-cell grouping combination and maintains a current sub-cell grouping combination, i.e., a current cell configuration.

FIG. 6 schematically illustrates an internal structure of a cell configuration apparatus in a wireless communication system according to an embodiment of the present disclosure.

Referring to FIG. 6, the cell configuration apparatus 600 includes a transmitter 611, a controller 613, a receiver 615, and a memory 617.

The controller 613 controls the overall operation of the cell configuration apparatus 600. For example, the controller 613 controls the cell configuration apparatus 600 to perform an operation corresponding to a method for configuring a cell, i.e., on of an initial cell configuration method, an automatic cell configuration method, and an automatic optimal cell configuration method. The operation corresponding to the method for configuring the cell is performed in the manner described before with reference to FIGS. 2 to 5. A description thereof will be omitted herein.

The transmitter 611 transmits signal and messages under a control of the controller 613.

The receiver 615 receives signal and messages under a control of the controller 613.

The memory 617 stores programs, equations and data related to the operation corresponding to the method for configuring the cell in the cell configuration apparatus 600 in FIGS. 2 to 5.

While the transmitter 611, the controller 613, the receiver 615, and the memory 617 are shown in FIG. 6 as separate units, it is to be understood that this is for merely convenience. That is, two or more of the transmitter 611, the controller 613, the receiver 615, and the memory 617 may be incorporated into a single unit.

As is apparent from the foregoing description, an embodiment of the present disclosure enables to configure a cell thereby minimizing a number of handover occurrences for a UE and additionally deploying a cell in a wireless communication system.

An embodiment of the present disclosure considers configuring a cell to prevent interference among cells which have been already deployed and additionally deploying a cell in a wireless communication system.

Another embodiment of the present disclosure considers configuring a cell thereby additionally deploying a cell in order to expand cell coverage and increase total network capacity in a wireless communication system.

Still another embodiment of the present disclosure considers configuring a cell thereby additionally deploying a cell without interference among old cells which have been already deployed in order to expand cell coverage and increase total network capacity in a wireless communication system.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for configuring a cell in a wireless communication system, the method comprising:
generating a virtual field based on information on a Remote Radio Header (RRH);
generating grids in the virtual field at intervals;
generating a virtual coverage map by regarding each of the grids as a virtual User Equipment (UE) and determining a serving RRH for each of the virtual UEs;
determining grids which are located at a boundary region among RRHs among grids included in the virtual coverage map as boundary region grids;
configuring a cell such that the cell includes less than or equal to a maximum sub-cell number of sub-cells, excluding boundary region grids included in a same cell among the boundary region grids from the boundary region grids, and selecting a sub-cell grouping combination which has a minimum number of boundary region grids among all sub-cell grouping combinations; and
configuring the cell using the selected sub-cell grouping combination,
wherein the maximum sub-cell number is permitted per each cell in the wireless communication system.

2. The method of claim 1, wherein the information on the RRH includes location information and antenna associated information of the RRH.

3. The method of claim 1, wherein the serving RRH for each of the virtual UEs comprises an RRH which has maximum received reference signal strength for each of the virtual UEs if transmission power, antenna gain and path loss for each RRH are set as virtual values.

4. The method of claim 1, wherein the sub-cell grouping combination comprises a sub-cell group which is generated using a sub-cell grouping scheme, and
wherein the sub-cell grouping scheme comprises a scheme in which a sub-cell group is generated such that a total number of handover occurrences in the wireless communication system is minimized.

5. The method of claim 1, wherein the sub-cell grouping combination comprises a sub-cell group which is generated using a sub-cell grouping scheme, and
wherein the sub-cell grouping scheme comprises a scheme in which a sub-cell group is generated such that a function value is minimized for the following equation:
$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}}$$
where, TotalHO denotes the total number of handover occurrences in the wireless communication system, N_{cell} denotes a total number of cells included in the wireless communication system, N_{subcell}_{ⱼ} denotes a number of sub-cells included in a jth cell, and N_{edgel}_{_{il,jk}} denotes a number of boundary regions which are overlapped with an lth sub-cell included in an ith cell among boundary regions for a kth sub-cell included in the jth cell.

6. A method for configuring a cell in a wireless communication system, the method comprising:
detecting sub-cell information on a new sub-cell in which a Remote Radio Header (RRH) is deployed;
detecting cell configuration information for old sub-cells;
detecting received power from the old sub-cells to the new sub-cell using a path loss function, an antenna parameter and transmission power information;
detecting a sub-cell grouping combination in which a total number of handover occurrences in the wireless communication system is minimized and a sum of received power in the new sub-cell is minimized from among all sub-cell grouping combinations which are possible to be generated in the wireless communication system; and
configuring a cell using the detected sub-cell grouping combination.

7. The method of claim 6, wherein the sub-cell information on the new sub-cell includes location information and antenna associated information of the new sub-cell.

8. The method of claim 6, wherein the sub-cell grouping combination comprises a sub-cell group which is generated using a sub-cell grouping scheme, and
wherein the sub-cell grouping scheme comprises a scheme in which a sub-cell group is generated such that the total number of handover occurrences in the wireless communication system is minimized.

9. The method of claim 6, wherein the sub-cell grouping combination comprises a sub-cell group which is generated using a sub-cell grouping scheme, and
wherein the sub-cell grouping scheme comprises a scheme in which a sub-cell group is generated such that a function value is minimized for the following equation:
$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}}$$
where, TotalHO denotes the total number of handover occurrences in the wireless communication system, N_{cell} denotes a total number of cells included in the wireless communication system, N_{subcell}_{ⱼ} denotes a number of sub-cells included in a jth cell, and N_{edgel}_{_{il,jk}} denotes a number of boundary regions which are overlapped with an lth sub-cell included in an ith cell among boundary regions for a kth sub-cell included in the jth cell.

10. The method of claim 6, wherein the sub-cell grouping combination in which the total number of handover occurrences in the wireless communication system is minimized is selected for satisfying the following equation:
$$arg min \{ TotalHO \} = arg min {\sum }_{k = 0}^{{N}_{{subcell}_{eNBindex}} - 1} {\sum }_{{k}^{′} = 0}^{{N}_{{subcell}_{eNBindex}} - 1} {α}_{k , {k}^{′}} \cdot R \times {P}_{{k}^{′} , k} , \\ {α}_{k , {k}^{′}} = \{ \begin{matrix}1 , & {subcell}_{k} \cdot CellIndex \neq {subcell}_{{k}^{′}} \cdot CellIndex \\ 0 , & {subcell}_{k} \cdot CellIndex = {subcell}_{{k}^{′}} \cdot CellIndex\end{matrix}$$
where, TotalHO denotes the total number of handover occurrences in the wireless communication system, eNBindex denotes an index of an enhance Node B (eNB) into which a sub-cell is added, N_{subcell}_{ᵢ} denotes a number of sub-cells included in a cell which an ith eNB manages, and RxP_{k′k} denotes received power for a kth sub-cell in a k′th sub-cell.

11. A method for configuring a cell in a wireless communication system, the method comprising:
collecting movement information for a User Equipment (UE) among sub-cells included in the wireless communication system;
if an automatic optimal cell configuration period is reached, detecting a sub-cell grouping combination in which a total number of handover occurrences in the wireless communication system is minimized from among all sub-cell grouping combinations which are possible to be generated in the wireless communication system using the movement information for the UE; and
configuring a cell using the detected sub-cell grouping combination.

12. The method of claim 11, wherein the movement information for the UE includes a number of handover occurrences for the UE.

13. The method of claim 11, wherein the sub-cell grouping combination comprises a sub-cell group which is generated using a sub-cell grouping scheme, and
wherein the sub-cell grouping scheme comprises a scheme in which a sub-cell group is generated such that the total number of handover occurrences in the wireless communication system is minimized.

14. The method of claim 11, wherein the sub-cell grouping combination comprises a sub-cell group which is generated using a sub-cell grouping scheme, and
wherein the sub-cell grouping scheme comprises a scheme in which a sub-cell group is generated such that a function value is minimized for the following equation:
$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}}$$
where, TotalHO denotes the total number of handover occurrences in the wireless communication system, N_{cell} denotes a total number of cells included in the wireless communication system, N_{subcell}_{ⱼ} denotes a number of sub-cells included in a jth cell, and N_{edgel}_{_{il,jk}} denotes a number of boundary regions which are overlapped with an lth sub-cell included in an ith cell among boundary regions for a kth sub-cell included in the jth cell.

15. The method of claim 11, wherein the sub-cell grouping combination in which the total number of handover occurrences in the wireless communication system is minimized is selected for satisfying the following equation:
$$arg min \{ TotalHO \} = arg min {\sum }_{k = 0}^{{N}_{{subcell}_{eNBindex}} - 1} {\sum }_{{k}^{′} = 0}^{{N}_{{subcell}_{eNBindex}} - 1} {α}_{k , {k}^{′}} \cdot {subcell}_{k} \cdot {N}_{{move}_{{k}^{′}}} , \\ {α}_{r , {r}^{′}} = \{ \begin{matrix}1 , & {subcell}_{k} \cdot CellIndex \neq {subcell}_{{k}^{′}} \cdot CellIndex \\ 0 , & {subcell}_{k} \cdot CellIndex = {subcell}_{{k}^{′}} \cdot CellIndex\end{matrix}$$
where, TotalHO denotes the total number of handover occurrences in the wireless communication system, eNBindex denotes an index of an enhance Node B (eNB) into which a sub-cell is added, N_{subcell}_{ᵢ} denotes a number of sub-cells included in a cell which an ith eNB manages, RxP_{k′k} denotes received power for a kth sub-cell in a k′th sub-cell, and subcellₖ·N_{Move}_{_{k′}} denotes a number of UEs which move from a service coverage region of a k′th sub-cell to a service coverage region of a k sub-cell.

16. An apparatus for configuring a cell in a wireless communication system, the apparatus comprising:
a controller configured to generate a virtual field based on information on a Remote Radio Header (RRH), to generate grids in the virtual field at intervals, to generate a virtual coverage map by regarding each of the grids as a virtual User Equipment (UE) and determine a serving RRH for each of the virtual UEs, to determine grids which are located at a boundary region among RRHs among grids included in the virtual coverage map as boundary region grids, to configure a cell such that the cell includes less than or equal to a maximum sub-cell number of sub-cells, to exclude boundary region grids included in a same cell among the boundary region grids from the boundary region grids, to select a sub-cell grouping combination which has a minimum number of boundary region grids among all sub-cell grouping combinations, and to configure the cell using the selected sub-cell grouping combination,
wherein the maximum sub-cell number is permitted per each cell in the wireless communication system.

17. The apparatus of claim 16, wherein the information on the RRH includes location information and antenna associated information of the RRH.

18. The apparatus of claim 16, wherein the serving RRH for each of the virtual UEs comprises an RRH which has maximum received reference signal strength for each of the virtual UEs if transmission power, antenna gain and path loss for each RRH are set as virtual values.

19. The apparatus of claim 16, wherein the sub-cell grouping combination comprises a sub-cell group which is generated using a sub-cell grouping scheme, and
wherein the sub-cell grouping scheme comprises a scheme in which a sub-cell group is generated such that a total number of handover occurrences in the wireless communication system is minimized.

20. The apparatus of claim 16, wherein the sub-cell grouping combination comprises a sub-cell group which is generated using a sub-cell grouping scheme, and
wherein the sub-cell grouping scheme comprises a scheme in which a sub-cell group is generated such that a function value is minimized for the following equation:
$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}}$$
where, TotalHO denotes the total number of handover occurrences in the wireless communication system, N_{cell} denotes a total number of cells included in the wireless communication system, N_{subcell}_{ⱼ} denotes a number of sub-cells included in a jth cell, and N_{edgel}_{_{il,jk}} denotes a number of boundary regions which are overlapped with an lth sub-cell included in an ith cell among boundary regions for a kth sub-cell included in the jth cell.

21. An apparatus for configuring a cell in a wireless communication system, the apparatus comprising:
a controller configured to detect sub-cell information on a new sub-cell in which a Remote Radio Header (RRH) is deployed, to detect cell configuration information for old sub-cells, to detect received power from the old sub-cells to the new sub-cell using a path loss function, an antenna parameter and transmission power information, to detect a sub-cell grouping combination in which a total number of handover occurrences in the wireless communication system is minimized and a sum of received power in the new sub-cell is minimized from among all sub-cell grouping combinations which are possible to be generated in the wireless communication system, and to configure a cell using the detected sub-cell grouping combination.

22. The apparatus of claim 21, wherein the sub-cell information on the new sub-cell includes location information and antenna associated information of the new sub-cell.

23. The apparatus of claim 21, wherein the sub-cell grouping combination comprises a sub-cell group which is generated using a sub-cell grouping scheme, and
wherein the sub-cell grouping scheme comprises a scheme in which a sub-cell group is generated such that the total number of handover occurrences in the wireless communication system is minimized.

24. The apparatus of claim 21, wherein the sub-cell grouping combination comprises a sub-cell group which is generated using a sub-cell grouping scheme, and
wherein the sub-cell grouping scheme comprises a scheme in which a sub-cell group is generated such that a function value is minimized for the following equation:
$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}}$$
where, TotalHO denotes the total number of handover occurrences in the wireless communication system, N_{cell} denotes a total number of cells included in the wireless communication system, N_{subcell}_{ⱼ} denotes a number of sub-cells included in a jth cell, and N_{edgel}_{_{il,jk}} denotes a number of boundary regions which are overlapped with an lth sub-cell included in an ith cell among boundary regions for a kth sub-cell included in the jth cell.

25. The apparatus of claim 21, wherein the sub-cell grouping combination in which the total number of handover occurrences in the wireless communication system is minimized is selected for satisfying the following equation:
$$arg min \{ TotalHO \} = arg min {\sum }_{k = 0}^{{N}_{{subcell}_{eNBindex}} - 1} {\sum }_{{k}^{′} = 0}^{{N}_{{subcell}_{eNBindex}} - 1} {α}_{k , {k}^{′}} \cdot R \times {P}_{{k}^{′} , k} , \\ {α}_{k , {k}^{′}} = \{ \begin{matrix}1 , & {subcell}_{k} \cdot CellIndex \neq {subcell}_{{k}^{′}} \cdot CellIndex \\ 0 , & {subcell}_{k} \cdot CellIndex = {subcell}_{{k}^{′}} \cdot CellIndex\end{matrix}$$
where, TotalHO denotes the total number of handover occurrences in the wireless communication system, eNBindex denotes an index of an enhance Node B (eNB) into which a sub-cell is added, N_{subcell}_{ᵢ} denotes a number of sub-cells included in a cell which an ith eNB manages, and RxP_{k′k} denotes received power for a kth sub-cell in a k′th sub-cell.

26. An apparatus for configuring a cell in a wireless communication system, the apparatus comprising:
a controller configured to collect movement information for a User Equipment (UE) among sub-cells included in the wireless communication system, if an automatic optimal cell configuration period occurs, to detect a sub-cell grouping combination in which a total number of handover occurrences in the wireless communication system is minimized from among all sub-cell grouping combinations which are possible to be generated in the wireless communication system using the movement information for the UE, and to configure a cell using the detected sub-cell grouping combination.

27. The apparatus of claim 26, wherein the movement information for the UE includes a number of handover occurrences for the UE.

28. The apparatus of claim 26, wherein the sub-cell grouping combination comprises a sub-cell group which is generated using a sub-cell grouping scheme, and
wherein the sub-cell grouping scheme comprises a scheme in which a sub-cell group is generated such that the total number of handover occurrences in the wireless communication system is minimized.

29. The apparatus of claim 26, wherein the sub-cell grouping combination comprises a sub-cell group which is generated using a sub-cell grouping scheme, and
wherein the sub-cell grouping scheme comprises a scheme in which a sub-cell group is generated such that a function value is minimized for the following equation:
$$arg min \{ TotalHO \} = arg min {\sum }_{j = 1}^{{N}_{cell} - 1} {\sum }_{k = 0}^{{N}_{{subcell}_{j}} - 1} {\sum }_{{i = 0}_{i \neq j}}^{{N}_{cell} - 1} {\sum }_{l = 0}^{{N}_{{subcell}_{i}} - 1} {N}_{{edge}_{il , jk}}$$
where, TotalHO denotes the total number of handover occurrences in the wireless communication system, N_{cell} denotes a total number of cells included in the wireless communication system, N_{subcell}_{ⱼ} denotes a number of sub-cells included in a jth cell, and N_{edgel}_{_{il,jk}} denotes a number of boundary regions which are overlapped with an lth sub-cell included in an ith cell among boundary regions for a kth sub-cell included in the jth cell.

30. The apparatus of claim 26, wherein the sub-cell grouping combination in which the total number of handover occurrences in the wireless communication system is minimized is selected for satisfying the following equation:
$$arg min \{ TotalHO \} = arg min {\sum }_{k = 0}^{{N}_{{subcell}_{eNBindex}} - 1} {\sum }_{{k}^{′} = 0}^{{N}_{{subcell}_{eNBindex}} - 1} {α}_{k , {k}^{′}} \cdot {subcell}_{k} \cdot {N}_{{move}_{{k}^{′}}} , \\ {α}_{r , {r}^{′}} = \{ \begin{matrix}1 , & {subcell}_{k} \cdot CellIndex \neq {subcell}_{{k}^{′}} \cdot CellIndex \\ 0 , & {subcell}_{k} \cdot CellIndex = {subcell}_{{k}^{′}} \cdot CellIndex\end{matrix}$$
where, TotalHO denotes the total number of handover occurrences in the wireless communication system, eNBindex denotes an index of an enhance Node B (eNB) into which a sub-cell is added, N_{subcell}_{ⱼ} denotes a number of sub-cells included in a cell which an ith eNB manages, RxP_{k′k} denotes received power for a kth sub-cell in a k′th sub-cell, and subcellₖ·N_{Move}_{_{k′}} denotes a number of UEs which move from a service coverage region of a k′th sub-cell to a service coverage region of a k sub-cell.
